(19) United States
(12) Patent Application Publication
(10) Pub. No.: US 2015/0244109 A1
(43) Pub. Date: Aug. 27, 2015

(54) Actuator With Dual Finger Grip Portions

(71) Applicants: Barbara Byczkiewicz, Westford, MA (US); Bruce Reed, Maumelle, AR (US)

(72) Inventors: Barbara Byczkiewicz, Westford, MA (US); Bruce Reed, Maumelle, AR (US)

(73) Assignee: Molex Incorporated, Lisle, IL (US)

(21) Appl. No.: 14/191,956

(22) Filed: Feb. 27, 2014

(51) Int. Cl. H01R 13/633

(52) U.S. Cl. CPC H01R 13/6335

(57) ABSTRACT

A low profile cable connector for use with electronic devices has a connector body with a latching member supported thereon. The latching member is mounted to the connector body so that it may be selectively moved up or down by way of an actuator. The actuator takes the form of a pull tab and extends axially along the cable that enters the connector body. The actuator has a first pull ring disposed on one side of the cable and a second pull ring in the form of a pull loop disposed on the other side of the cable so that the actuator may be operated from either side of the cable. The pull loop is formed in part by a pair of arms extending from the actuator away from the first pull ring to thereby define an intervening space through which the cable extends.

### BACKGROUND OF THE PRESENT DISCLOSURE

The Present Disclosure relates, generally, to low profile connectors, and, more particularly, to improved means if actuating such connectors utilizing redundant pull tab structures.

Small and low-profile connectors, such as those used in SFP (Small Form Factor Pluggable) applications are utilized in electronic devices, in which space is a premium. Such connectors are widely used to make connections with routers and servers. They are small in size, but one problem with many electronic connectors of this type, however, is the tendency for them to separate or be disconnected from the component to which they are connected. Thus, it is common to latch such connectors together. One example of a plug connector using a latch is U.S. Pat. No. 5,915,987, issued 29 Jun. 1999 for “Latched Electrical Connector” (the content of which is hereby incorporated herein in its entirety), and which discloses a plug-receptacle connector assembly with a latching mechanism incorporated into the housing of the plug connector. Latching mechanisms on plug connectors require an actuator that permits the operator to raise and lower the latching member to latch and unlatch a plug connector from its corresponding receptacle connector. The size and locations of the actuators sometimes increase the size required in a system.

As connectors become smaller and the density of receptacle connectors in electronic devices increases, the simple act of disengaging a plug connector latch mechanism becomes increasingly more difficult. Some latching mechanisms for low profile latching connector use a single pull tab that extends axially rearwardly along the connector cable to define a grasping point for the operator. Such a pull tab is shown in U.S. Pat. No. 7,354,292, issued 8 Apr. 2008 and assigned to the assignee of the Present Disclosure (the content of which is hereby incorporated by reference herein in its entirety). However, these types of pull tabs extend along only a single orientation of their associated connectors, i.e., either the top or bottom of the cable. Its tight wiring closets it can become difficult to access and grasp the pull tab to remove the connector. A need therefore exists for a low profile connector having a pull tab actuator-type structure that is accessible notwithstanding the orientation of the connector.

The Present Disclosure is therefore directed to a low profile connector with a redundant, or dual pull tab, actuator particularly suitable for dense cable arrangements, wherein the actuator may be operated regardless of the orientation of the connector.

### SUMMARY OF THE PRESENT DISCLOSURE

Accordingly, there is provided a low profile latching connector, suitable for dense wiring applications, having an actuator accessible from two opposing sides of the connector cable and operable by way of a simple pull-type action.

In accordance with an embodiment described in the following Present Disclosure, a low profile latching connector is provided comprised of a hollow, generally rectangular body portion from which a similarly rectangular mating portion projects. A latching member extends lengthwise of the connector and is fixed near a rear end thereof to the connector body portion and extends in a cantilevered fashion forwardly such that its front end lies upon the mating portion. An actuator is provided that has an elongated body which fits between the latching member and the connector body portion that has a configuration which causes the latching member front end to rise and fall in response to lengthwise movement of the actuator.

The actuator preferably includes a first grip portion with a pull tab having a ring in the form of a finger hole at its rear end into which an operator can use to pull the actuator rearwardly, or push it forwardly. The actuator and plug connector include cooperating structure that limits the travel of the actuator. In order to provide the actuator with a measure of redundancy, a second grip portion with a pull tab in the form of a pull loop is provided and it also extends rearwardly along the connector cable. The pull loop is positioned in general opposition to the pull ring and also includes a finger hole at its rear end into which an operator can use to pull the actuator rearwardly, or push it forwardly. Importantly, the pull ring and loop are spaced apart from each other by an intervening space through which the connector cable extends. In this regard, the pull ring and loop are preferably arranged parallel, to be grasped either individually or as a pair.

The actuator includes a pair of arms that extend outwardly and downwardly to an opposite side of the connector cable where they join with the second grip portion to cooperatively define the pull loop that encircles the cable. The arms preferably extend downwardly away from the actuator body at an acute angle to better transfer pulling forces on the second grip to the actuator body. The actuator body is further preferably formed with a radius, which provides the actuator body with a round edge in contact with the connector cable(s) to facilitate the sliding of the entire actuator along the connector cable.

These and other objects, features and advantages of the Present Disclosure will be clearly understood through a consideration of the following detailed description.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 illustrates a cable connector having a latching mechanism that utilizes an actuator, in accordance with the Present Disclosure;

FIG. 2 is a side elevational view of the connector of FIG. 1, with the actuator shown sectioned along its exterior extent, rear of the connector housing;

FIG. 3 is a rear elevational view of the connector of FIG. 1, with two cables exiting the connector;

FIG. 4A is a top perspective view of the actuator of the connector of FIG. 1;

FIG. 4B is the same view as FIG. 4A, but taken from the bottom;

FIG. 4C is an enlarged elevational view of the rear of the actuator of FIG. 4A;

FIG. 4D is an elevational view illustrating an alternate construction of the dual pull tab actuator of the Present Disclosure;

FIG. 5 is an enlarged elevational side view, taken in section, of the rear end of the actuator of FIG. 4A; and

FIG. 6 is a top plan view of the connector of FIG. 1.

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

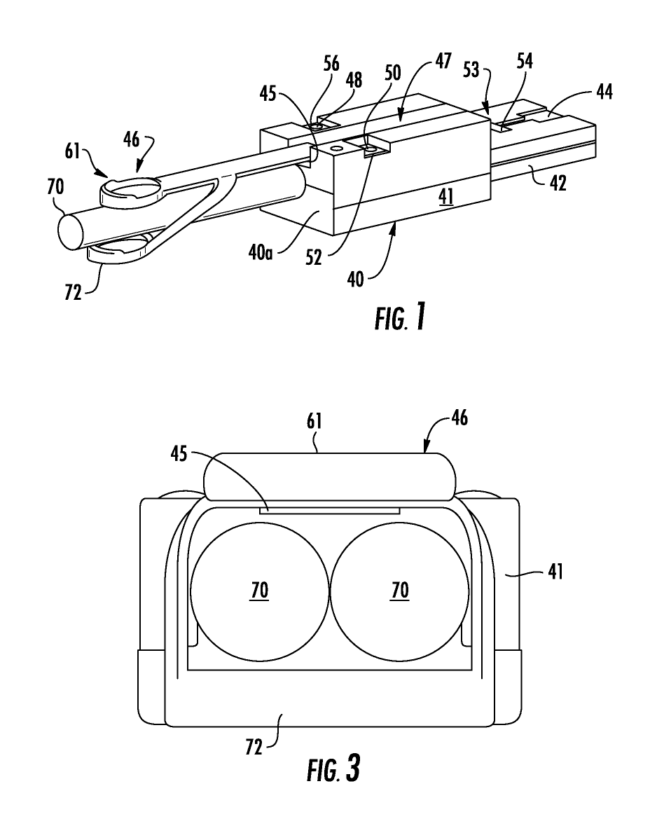

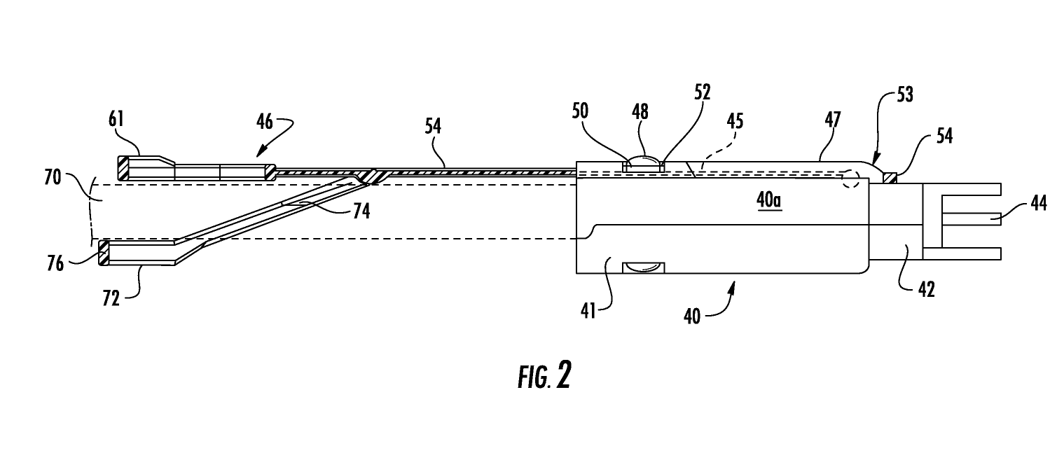

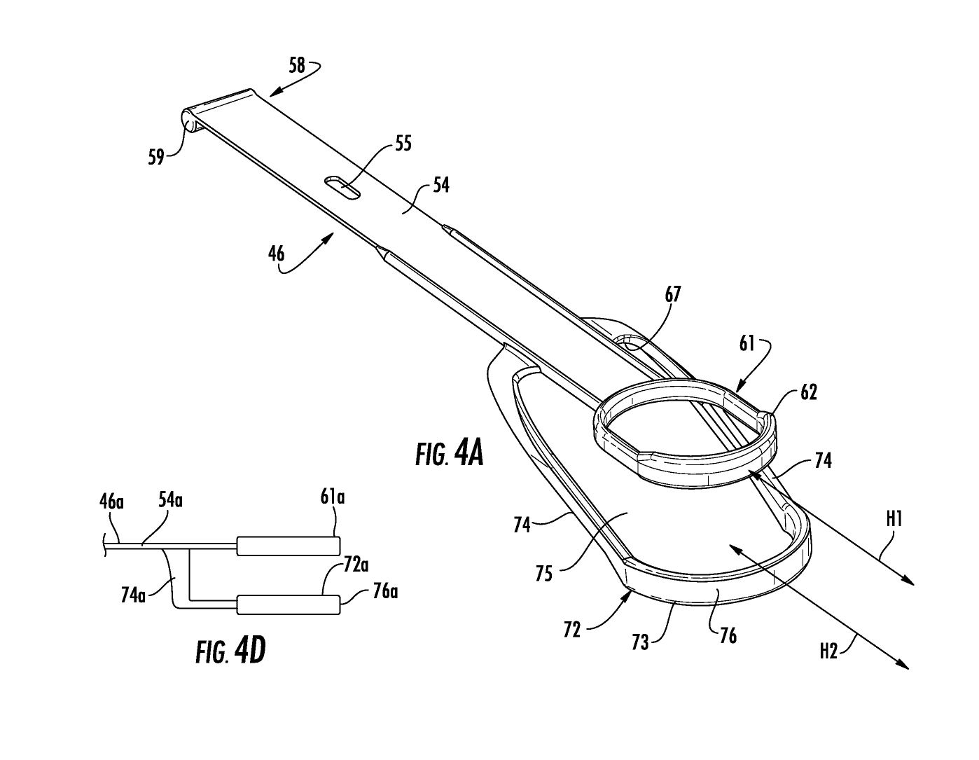

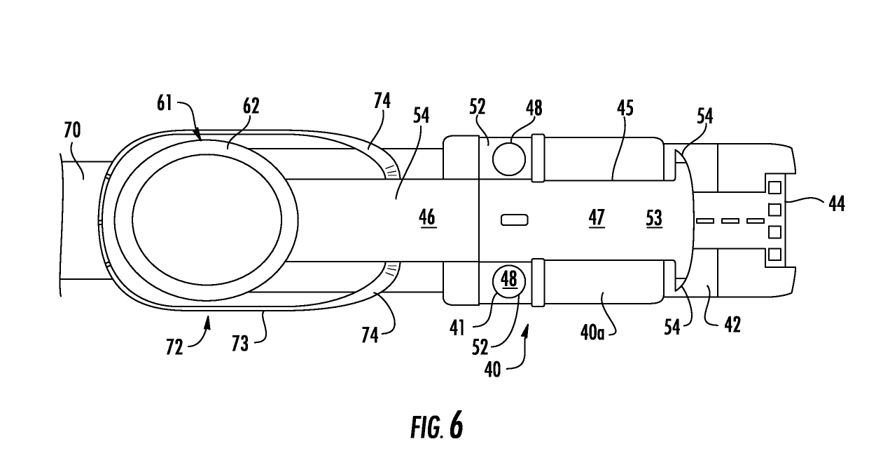

FIGS. 1-6 illustrate a cable connector 40 constructed in accordance with the Present Disclosure and which uses a redundant, or dual pull tab, actuator 46. The cable connector 40 has a two-part connector housing 40a which includes a relatively large body portion 41 and a smaller nose, or mating portion, 42 that partially encloses a circuit board 44 that mates with contacts of a corresponding opposing connector (not shown) mounted to a larger circuit board of an electronic device. The connector 40 is used to connect multiple wires in either a single cable or multiple cables 70 with circuits of an electronic device. The housing body portion 41 includes a lengthwise channel 45 that extends for the length of the housing body portion 41. This channel 45 accommodates an actuator 46 therein and further accommodates an elongated latching member 47 that overlies a portion of the actuator 46. The latching member 47 is shown secured near its rear end to the housing body portion 41 by two fasteners 48 that pass through holes 50 in wings 52 of the latching member 47. This attachment fixes the latching member 47 to the connector housing 40a in a cantilevered fashion so that the free end 53 of the latching member 47 may move vertically in response to horizontal or lateral movement of the actuator 46. The latching member free end 53 may contain one or more engagement hooks 54 that engage openings on the corresponding opposing connector.

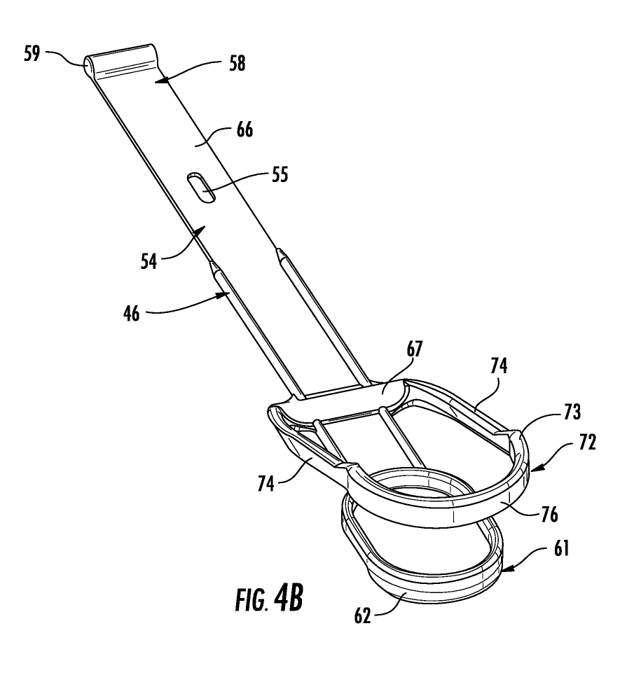

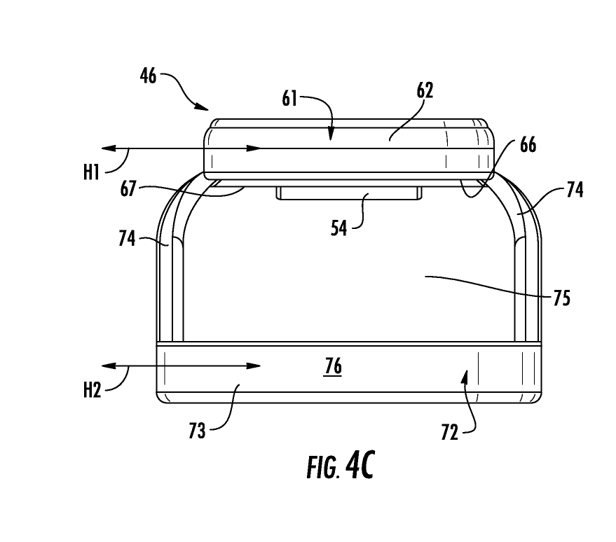

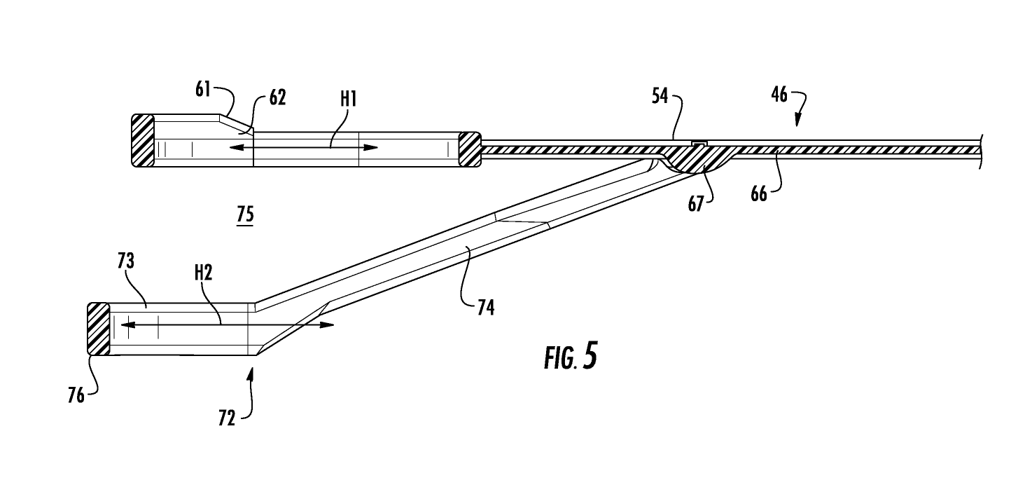

The actuator 46, as shown best in FIGS. 4A-C, includes an elongated body portion 54 having a width slightly less than the width of the housing channel 45 which will permit it to slide freely within the housing channel 45 in forward and rearward directions without interference. In order to limit the extent of the travel of the actuator 46 and prevent the actuator 46 from being pulled completely out of the connector 40, the actuator body portion 54 may include a travel limiting slot 55 that engages a stop member (not shown) disposed in the housing channel 45. The forward end 56 of the actuator 46 preferably includes an enlarged end portion 58, such as a lobe, or a roll pin 59, captured between the latching member 47 and either the housing channel 45 or a recess in the connector housing 40a or housing channel 45. This enlarged end portion 56 acts as a cam and rides against either a cam surface disposed on the connector housing 40a or disposed on the latching member 47 such that horizontal movement of it imparts vertical movement to the latching member free end 53.

Importantly, the actuator 46 has a pull tab style structure. That is, the actuator body portion 54 terminates at its rear end in a first grip portion 61, shown as a finger ring 62 that has a circular, or oval-like, configuration. As illustrated, the first grip portion 61 extends in a horizontal plane H1, which includes a portion of the actuator body portion 54. In doing so, the actuator body portion 54 and its associated first grip portion 61 extend along a first side of the connector cable(s) 70 and this side is shown in the Figures as the top side or in a plane that lies above the cable 70.

In order to give connectors of the Present Disclosure the ability to be latched from different directions, the actuator is further provided with a measure of redundancy, such as a second grip portion 72 which takes the form of a pull loop 73 spaced apart from the first grip portion 61. The second grip portion 72 is cooperatively defined by a pair of arms 74 that extend out and away from the actuator body portion 54 and down into a second plane H2 spaced apart by an intervening space 75 from the first plane H1. The two arms 74 are joined together by an arcuate end piece 76 such that a finger pull loop 74 is formed that encircles the connector cables 70. The arms 74 are shown extending downwardly from the actuator body portion 54 at an acute angle; this angular orientation transfers the pulling force exerted by the operator to the actuator body portion 54 so that the actuator 46 may be pulled rearwardly in a linear fashion along the first side of the cables 70.

As shown specifically in FIG. 4D, in an alternate embodiment particularly suitable for die-cast construction, the second grip portion loop arms 74a may also extend downwardly in a vertical fashion, transversely from the actuator body portion 54a, and with their end piece 76a connecting the arms 74a in a manner such that the actuator structure has an L-shaped configuration when viewed from the side. As shown, the second grip portion 72 may be slightly larger than the first grip portion 61. In the area where the pull loop arms 74 join the actuator body portion 54, the underside 66 thereof has an enlarged bead, or radius, 67 formed thereon (or attached as a separate piece), best shown in section in FIG. 5. The radius 67 provides a smooth surface bearing against and easily riding along the exterior of the top surfaces of the cable 70 when brought into contact with the cables 70 when the second grip portion 72 is pulled rearwardly. It is preferred that the radius 67 extend at least in the areas between the two arms 74, but it may also extend outwardly and downwardly along the interior of arms 74 to further facilitate movement of the actuator 46.

The presence of the two grip portions 61, 72 permits an operator to more easily actuate the latching member 47 regardless of the orientation of the connector housing 40a. If the connector housing 40a is installed in a conventional fashion, the operator can use the first (top) grip portion 61, and if the connector housing 40a is installed in an inverted fashion, the operator can use the second (bottom) grip portion 72. Of course, both grip portions 61, 72 may be grasped in situations where clearance is not an issue. Similarly, the connectors of the Present Disclosure may be mounted sideways, where the first and second grip portions tabs extend in vertically spaced-apart planes. The actuator may be formed from a plastic or resin, such as by molding or from a metal such as be die casting. The use of two grip portions utilizing the structure disclosed herein further does not increase the space needed in a wiring cabinet as the grip portions extend close to exteriors of the cables 70.

While a preferred embodiment of the Present Disclosure is shown and described, it is envisioned that those skilled in the art may devise various modifications without departing from the spirit and scope of the foregoing Description and the appended Claims.

What is claimed is:

1. A plug connector comprising:
a plug connector housing, the plug connector housing having a front portion and a rear portion, the front portion being sized to fit within an opposing mating receptacle connector, the rear portion being sized to receive an end of at least one multi-wire cable therein, the front portion including a first surface and the rear portion including a second surface disposed at a level above the first surface;
a latching member, the latching member including a first end attached to the second surface and a second, free end disposed forwardly of the first end, the second end extending over a portion of the first surface; and
an actuator, the actuator having a first end that protrudes beyond the rear portion and a second end that extends toward the front portion, a portion of the actuator being interposed between the latching member and the second surface, the actuator being sized, structured and arranged such that movement of the actuator away and toward the front portion causes the latching member second end to be raised and lowered relative to the first surface, the actuator first end including a first grip portion extending in a first plane and a second grip portion extending in a second plane, different than the first plane and spaced apart from the first grip portion to define an intervening space therebetween for accommodating the connector cable therein.

2. The connector of claim 1, wherein the first grip portion includes a pull ring and the second grip portion includes a pull loop.

3. The connector of claim 1, wherein one of the first and second grip portions has a non-planar configuration.

4. The connector of claim 1, wherein the actuator is plastic.

5. The connector of claim 2, wherein the actuator includes a planar body portion disposed in the first plane and extending from the rear portion to the first grip portion, and a pair of arms extending away from the planar body portion to the second grip portion.

6. The connector of claim 5, wherein the arms extend between the first and second planes at an angle.

7. The connector of claim 6, wherein the angle is an acute angle.

8. The connector of claim 5, further including an end piece joined to the arms to cooperatively define therewith the pull loop, the pull loop encircling each cable when the actuator is in place on the connector.

9. The connector of claim 5, further including a radius disposed on the body portion in opposition to each cable, for contacting the connector cable when pulled rearwardly.

10. The connector of claim 9, wherein the radius includes a raised portion disposed on an underside of the body portion, and extends at least between the arms.

11. The connector of claim 1, wherein the first and second grip portions are disposed respectively along top and bottom surfaces of each cable.

12. A connector with a selectively operable latching member and dual grip actuator, the connector comprising:
a connector housing, the connector housing having opposing front and rear ends, the front end being smaller in size than the rear end, the rear end receiving a wire cable therein such that the cable extends rearwardly out of the rear end;
a latching member, the latching member having opposing front and rear ends, the latching member being mounted to the housing so that the latching member front end is disposed in a cantilevered fashion and such that the latching member front end is capable of vertical movement; and
an actuator, the actuator being at least partially interposed between the latching member and the housing, the actuator including a front end and a rear end opposite the front end, the actuator front end being disposed adjacent the latching member such that linear movement of the actuator causes the latching member second end to be raised and lowered relative to the housing front end, the actuator rear end including spaced apart first and second grip portions extending along opposite sides of the cable to thereby permit an operator to grasp at least one of the grip portions to raise and lower the latching member.

13. The connector of claim 12, wherein the first grip portion extends in a first plane and the second grip portion extends in a second plane, the second grip portion including a pair of arms extending angularly between the first and second planes, the pair of arms being interconnected by an end piece to cooperatively define a loop that encircles the wire cable.

14. The connector of claim 13, wherein the first grip portion includes a pull ring and the second grip portion includes a pull loop.

15. The connector of claim 14, wherein the pull ring and pull loop are aligned with each other on opposite sides of the cable.

16. The connector of claim 13, wherein the actuator includes a radiused portion disposed thereon in opposition to the cable and proximate to where the arms join the actuator.

17. An actuator for a cable connector, the cable connector including a connector housing for receiving a termination end of at least one cable, a cantilevered latching member mounted to the housing so that a free, latching end thereof may be raised and lowered in accordance with lateral movement of the actuator, the actuator comprising:
a elongated body portion, the body portion including two ends, one end including an enlarged free end portion and the other end including a first grip portion, the body portion further including a pair of arms extending away therefrom and connected together by an end piece to cooperatively define a second grip portion, the first and second grip portions being spaced apart from each other by an intervening space sized to accommodate each cable therein.

18. The actuator of claim 17, wherein the first grip portion includes a pull ring and the second grip portion includes a pull loop.

19. The actuator of claim 17, further including a radiused portion disposed on an underside of the body portion in opposition to each one cable.

20. The actuator of claim 19, wherein the radiused section extends between the arms.
